(19) United States
(12) Patent Application Publication
(10) Pub. No.: US 2007/0143845 A1
(43) Pub. Date: Jun. 21, 2007

(54) Method of preventing leakage of personal information of user using server registration information and system using the method

(76) Inventors: Youn Seo Jeong, Daejeon-city (KR); Jong Ho Ryu, Cheonan-city (KR); Kook Han Kim, Daejeon-city (KR); Dong Il Seo, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/633,961

(22) Filed: Dec. 5, 2006

(30) Foreign Application Priority Data
Dec. 7, 2005 (KR) 10-2005-0119091
Aug. 1, 2006 (KR) 10-2006-0072647

(51) Int. Cl. G06F 12/14

(52) U.S. Cl. 726/22

(57) ABSTRACT

Provided are a method and system for preventing personal information of a user using server registration information and an authentication system connected to the Internet. The method includes collecting information regarding servers which provide an Internet service; classifying the safety of sites using the servers based on the information; and providing site information containing the information regarding the servers at the request of a client which tries to access the servers. In the method, addresses of servers of major organizations connected to a network are registered in advance. Therefore, when a terminal of a user tries to access an external site through the network, it is possible to identify which organization has actually registered an address of the site and determine whether the site is a harmful site. If the site is determined to be harmful, the access to the site is blocked, thereby preventing the damages of phishing.

### BACKGROUND OF THE INVENTION

This application claims the benefits of Korean Patent Application No. 10-2005-0119091, filed on Dec. 7, 2005,and Korean Patent Application No. 10-2006-0072647, filed on Aug. 1, 2006, in the Korean Intellectual Property Office, the disclosures of which are incorporated herein in their entirety by reference.

1. Field of the Invention

The present invention relates to an apparatus and method of preventing the leakage of personal information of a user, and more particularly, to an apparatus and method of collecting information regarding servers on the Internet, classifying the safety of the servers, and notifying users, who try to use the servers, of whether the servers are safe, and blocking the access to some of the servers determined to be harmful in order to intercept fraudulent e-mails used to steal financial or personal information of users.

2. Description of the Related Art

Conventional methods have been used to block the sending of a lot of spam mails which cause phishing, intercept e-mails with false sending addresses, and track phishing URLs based on the content of e-mails and block the phishing URLs. However, these methods distinguish spam mails from legitimate mails simply by using statistical methods or block spam mails based on information accumulated in a database (DB).

Phishing is designed to gain personal or financial information by luring users to harmful and bogus servers which look like websites of legitimate financial or public institutions. To prevent phishing, users may verify websites to visit. However, it is not possible for users to determine whether servers that they try to access are those of legitimate organizations based on domain names or Internet protocol (IP) addresses of the servers. Therefore, actual addresses of major web servers (such as websites of public institutions and banks, and e-commerce sites) must be registered with a server so that users can verify the safety of sites to visit using the server. To this end, it is required to establish a web server authentication system, which can register public, financial and e-commerce servers, or actual addresses of businesses who are willing to enhance service reliability, and can respond to requests. In addition, an agent program for determining whether an address of a site to be accessed by a browser is a registered and safe address before the browser accesses the site and notifying a user of the determination result must be installed in a computer of the user.

### SUMMARY OF THE INVENTION

The present invention provides an apparatus and method of registering information regarding sites, which provide service, with an authentication server in a network and verifying the safety of a site based on the information before accessing the site.

According to an aspect of the present invention, there is provided a method of preventing the leakage of personal information of a user using server registration information and an authentication system connected to the Internet. The method includes collecting information regarding servers which provide an Internet service; classifying the safety of sites using the servers based on the information; and providing site information containing the information regarding the servers at the request of a client which tries to access the servers.

The collecting of the information may include collecting the information regarding the servers, the information containing Internet protocol (IP) addresses of the servers, using the authentication system; extracting IP addresses of servers used by reliable sites from the collected information; and classifying the servers having the extracted IP addresses according to domains of the reliable sites which use the servers and storing the collected information and the classification results in a database (DB).

According to another aspect of the present invention, there is provided a method of preventing the leakage of personal information of a user using server registration information in a communication network comprised of a plurality of servers connected to the network through the Internet, an authentication system storing information regarding the servers, and a server authentication client installed in a computer accessing the Internet. The method includes collecting addresses of the servers and information regarding sites which use the servers and classifying the safety of the sites by using the authentication system;

receiving information regarding a site to be accessed through the Internet from the authentication system by using the server authentication client, the information containing information regarding the safety of a server used by the site,; and

comparing and analyzing the received information and collected information regarding the sites and, if the received information and the collected information regarding the sites are different, temporarily blocking the access to the site, and asking a user whether to access the site

The receiving of the information regarding the site may include notifying the authentication system about a server address of the site that the computer tries to access; receiving the information regarding the site from the authentication system; and comparing the received information with the extracted information regarding the site.

According to another aspect of the present invention, there is provided a system for preventing the leakage of personal information of a user using server registration information. The system includes an authentication system collecting addresses of servers connected through the Internet and information regarding sites which use the servers and classifying the safety of the sites; a user computer accessing the Internet; and an authentication client installed in the user computer, receiving the information regarding the sites, and blocking the access of the user computer to harmful sites based on the received information.

The authentication client may include an access unit receiving from the authentication system, information regarding a site that the user computer tries to access through the Internet; a monitor unit monitoring the Internet access of the user computer; an address extraction unit extracting an IP address of the site that the user computer tries to access according to a command from the monitor unit which detects the Internet access of the user computer and outputting the extracted IP address of the site to the access unit; and an analysis unit comparing the extracted IP address with the received information.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating the network configuration of a system for preventing the leakage of personal information according to an embodiment of the present invention;

FIG. 2 is a detailed block diagram of a server authentication client illustrated in FIG. 1;

FIG. 3 is a flowchart illustrating a method of preventing the leakage of information according to an embodiment of the present invention;

FIG. 4 is a flowchart illustrating an operation of preventing the leakage of information using a server authentication system in the method of FIG. 3; and

FIG. 5 is a detailed flowchart of the method illustrated in FIG. 3.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

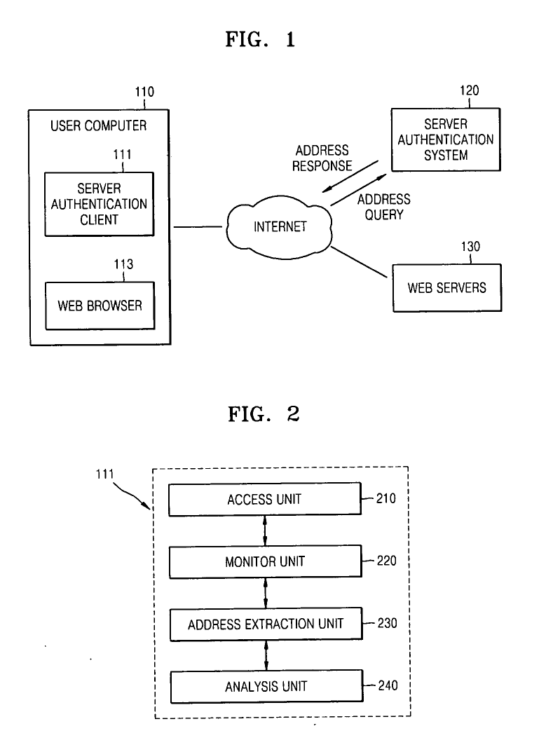

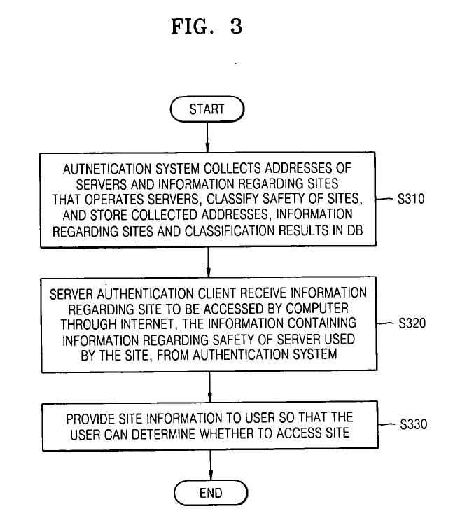

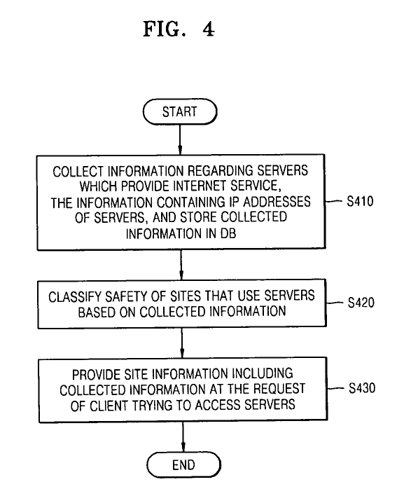

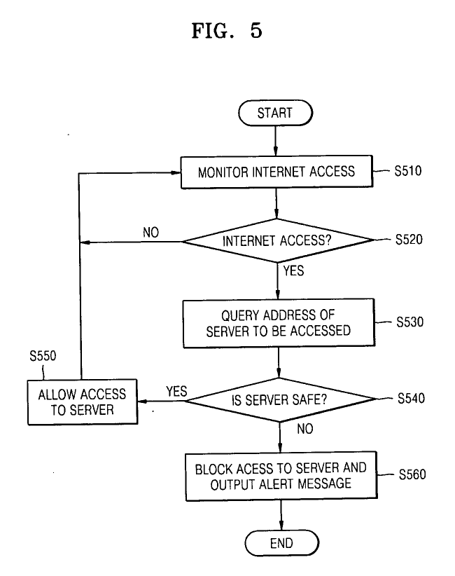

FIG. 1 is a diagram illustrating the network configuration of a system for preventing the leakage of personal information according to an embodiment of the present invention. FIG. 2 is a detailed block diagram of a server authentication client 111 illustrated in FIG. 1. FIG. 3 is a flowchart illustrating a method of preventing the leakage of information according to an embodiment of the present invention. FIG. 4 is a flowchart illustrating an operation of preventing the leakage of information using a server authentication system 120 in the method of FIG. 3. FIG. 5 is a detailed flowchart of the method illustrated in FIG. 3.

Referring to FIG. 1, the system for preventing the leakage of personal information includes a server authentication system 120 collecting addresses of a plurality of web servers 130 accessed through the Internet and information regarding sites that use the web servers 130 and classifying the safety of the sites, a user computer 110 accessing the Internet, and the server authentication client 111 installed in the user computer 110 and blocking the access of the user computer 110 to harmful sites.

The server authentication system 120 collects Internet protocol (IP) addresses and relevant information of the web servers 130 and stores the collected IP addresses and relevant information in a database (DB) in operation S410. Based on the IP addresses and relevant information stored in the DB, the server authentication system 120 extracts the IP addresses of servers used by reliable sites, classifies the servers having the extracted IP addresses according to domains of sites that use the servers, and stores the classification results in the DB in operation S420. While maintaining such information in the DB, if a user tries to access a site, the server authentication system 120 provides information regarding the site to the user at the request of the server authentication client 111 in operation S430.

The operation of the server authentication client 111 will now be described in detail. The server authentication client 111 monitors all access of a user terminal, i.e., the user computer 110, requests the server authentication system 120 for information regarding a server having an address that the user computer 110 tries to access, and informs a user of the information. More specifically, an access unit 210 included in the server authentication unit 111 receives information regarding a site that the user computer 110 tries to access through the Internet from the server authentication system 120. A monitor unit 220 constantly monitors the Internet access of the user computer 110 and, if the user accesses the Internet, notifies an address extraction unit 230 of the Internet access. The address extraction unit 230 extracts an IP address of the site that the user computer 110 tries to access in response to a command from the monitor unit 220 and notifies an analysis unit 240 of the extracted IP address. The analysis unit 240 compares the extracted IP address with the received information and, if they are different, blocks the access of the user computer 110 to the site and outputs the analysis result to the access unit 210 so that the user can determine whether to continue to access the site.

Referring to FIG. 3, the method of preventing the leakage of information according to the embodiment of the present invention is summarized.

First of all, the server authentication system 120 collects addresses of servers and information regarding sites that use the servers, classifies the safety of the sites, and stores the collected addresses of the servers, the information regarding the sites and the classification results in a DB in order to provide them when requested. The server authentication system 120 stores names and IP addresses of the servers, domain names, names of service providers, contact information, and registration dates in the DB. In this case, server information must be registered using a confirmed and verified method and must be authenticated for reliability in operation S310. Next, the server authentication client 111 requests the server authentication system 120 for information regarding a site that the user computer 110 tries to access through the Internet, the information containing information regarding the safety of a server used by the site, and receives the information in operation S320. The information is provided to a user so that the user can determine whether to block the access to the site in operation S330.

Operations included in the method of preventing the leakage of information will now be sequentially described with reference to FIG. 5. The server authentication client 111 constantly monitors whether a user accesses the Internet in operation S510. If the server authentication client 111 determines that the user accesses the Internet in operation S520, the server authentication client 111 requests the server authentication system 120 for information regarding a server having an address that the user tries to access in operation S530. The server authentication client 111 determines whether the server is safe based on the information provided by the server authentication system 120 at the request of the server authentication client 111 in operation S540. If the server authentication client 111 determines in operation S540 that the server is safe, the server authentication client 111 allows the access to the server in operation S550. However, if the server authentication client 111 determines in operation S540 that the server is not safe, the server authentication client 111 blocks the access to the server and outputs an alert message to the user in operation S560.

As described above, in a method of preventing the leakage of user information using server registration information and a system using the method according to the present invention, addresses of servers of major organizations connected to a network are registered in advance. Therefore, when a terminal of a user tries to access an external site through the network, it is possible to identify which organization has actually registered an address of the site and determine whether the site is a harmful site. If the site is determined to be harmful, the access to the site is blocked, thereby preventing the damages of phishing.

In addition, since the user can identify access addresses of external destinations of all data transmitted from the terminal of the user based on obtained site information, the leakage of personal information can be prevented.

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preventing the leakage of personal information of a user using server registration information, wherein an authentication system connected to the Internet protects the personal information, the method comprising:
collecting information regarding servers which provide an Internet service;
classifying the safety of sites using the servers based on the information; and
providing site information containing the information regarding the servers at the request of a client which tries to access the servers.

2. The method of claim 1, wherein the collecting of the information comprises:
collecting the information regarding the servers, the information containing Internet protocol (IP) addresses of the servers, by using the authentication system;
extracting IP addresses of servers used by reliable sites from the collected information; and
classifying the servers having the extracted IP addresses according to domains of the reliable sites which use the servers and storing the collected information and the classification results in a database (DB).

3. The method of claim 2, wherein, in the extracting of the IP addresses, public sites are determined to be reliable and safe sites.

4. The method of claim 1, wherein the site information comprises names and IP addresses of the servers, domain names, names of service providers, contact information, and registration dates.

5. A method of preventing the leakage of personal information of a user in a communication network comprised of a plurality of servers connected to the network through the Internet, an authentication system storing information regarding the servers, and a server authentication client installed in a computer accessing the Internet, the method comprising:
collecting addresses of the servers and information regarding sites which use the servers and classifying the safety of the sites by using the authentication system;
receiving information regarding a site to be accessed through the Internet from the authentication system by using the server authentication client, the information containing information regarding the safety of a server used by the site,; and
comparing and analyzing the received information and collected information regarding the sites and, if the received information and the collected information regarding the sites are different, temporarily blocking the access to the site, and asking a user whether to access the site.

6. The method of claim 5, wherein the collecting of the addresses of the servers and the information regarding the sites comprises:
collecting the information regarding the servers, the information containing IP addresses of the servers, by using the authentication system;
extracting IP addresses of servers used by reliable sites from the collected information; and
classifying the servers having the extracted IP addresses according to domains of the reliable sites which use the servers and storing the collected information and the classification results in a DB.

7. The method of claim 6, wherein, in the extracting of the IP addresses, public sites are determined to be reliable and safe sites.

8. The method of claim 5, wherein the receiving of the information regarding the site comprises:
notifying the authentication system of a server address of the site that the computer tries to access;
receiving the information regarding the site from the authentication system; and
comparing the received information with the extracted information regarding the site.

9. The method of claim 5, wherein the information regarding the sites comprises names and IP addresses of the servers, domain names, names of service providers, contact information, and registration dates.

10. The method of claim 5, wherein the comparing and analyzing of the received information and the extracted information further comprises determining whether to continuously access the site through the Internet based on the user's decision.

11. A system for preventing the leakage of personal information of a user using server registration information, the system comprising:
an authentication system collecting addresses of servers connected through the Internet and information regarding sites which use the servers and classifying the safety of the sites;
a user computer accessing the Internet; and
an authentication client installed in the user computer, receiving the information regarding the sites, and blocking the access of the user computer to harmful sites based on the received information.

12. The system of claim 11, wherein the authentication system collects IP addresses and relevant information of the servers, extracts IP addresses of servers used by reliable sites, classifies the servers having the extracted IP addresses according to domains of the reliable sites which use the servers, and stores the collected IP addresses and relevant information of the servers and the classification results in a DB.

13. The system of claim 11, wherein the authentication client comprises:
an access unit receiving from the authentication system, information regarding a site that the user computer trying to access through the Internet;
a monitor unit monitoring the Internet access of the user computer;
an address extraction unit extracting an IP address of the site that the user computer trying to access according to a command from the monitor unit which detects the Internet access of the user computer and outputting the extracted IP address of the site to the access unit; and
an analysis unit comparing the extracted IP address with the received information.
